(19) United States
(12) Patent Application Publication
(10) Pub. No.: US 2014/0196333 A1
(43) Pub. Date: Jul. 17, 2014

(54) MOUNTING DEVICE FOR DISPLAY STRIP IN VENDING MACHINE

(71) Applicant: HON HAI PRECISION INDUSTRY CO., LTD., New Taipei (TW)

(72) Inventors: YUN-LUNG CHEN, New Taipei (TW); CHIN-WEN YEH, New Taipei (TW)

(73) Assignee: HON HAI PRECISION INDUSTRY CO., LTD., New Taipei (TW)

(21) Appl. No.: 14/015,756

(22) Filed: Aug. 30, 2013

(30) Foreign Application Priority Data
Jan. 17, 2013 (CN) 2013100165813

(51) Int. Cl. G09F 23/00

(52) U.S. Cl. CPC G09F 23/00
USPC 40/606.04

(57) ABSTRACT

A mounting device includes a bottom plate of a chassis, and a frame. The frame includes a holding plate and a limiting portion extending from the holding plate. The holding plate is integrally formed with the bottom plate. The limiting portion and the holding plate cooperatively define a gap for receiving a display strip therebetween.

### BACKGROUND

1. Technical Field

The present disclosure relates to a vending machine, and particularly to a mounting device for a display strip in the vending machine.

2. Description of Related Art

In many vending machines, a display strip is used for displaying temperatures and prices. The display strip is riveted to a fastener in a bottom plate of a channel by butterfly shape nuts. However, the securing process of the display strip is time-consuming, and a structure of the display strip is complicated and costly. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of a mounting device and a display strip.

FIG. 2 is an enlarged view of a circled portion II of FIG. 1.

FIG. 3 is an assembled, isometric view of the mounting device and the display strip of FIG. 1.

FIG. 4 is a side view of the mounting device and the display strip of FIG. 3.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

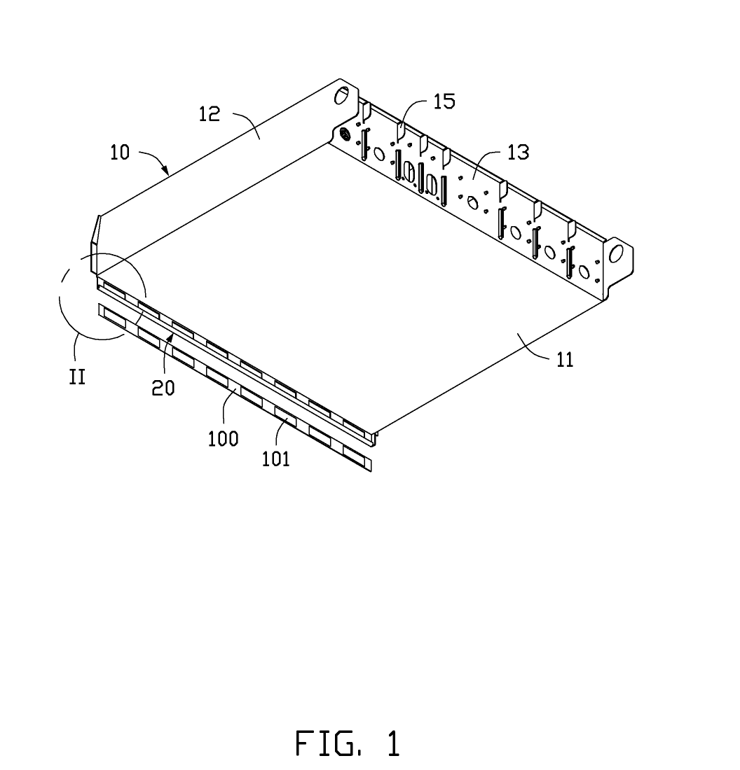

FIG. 1 shows one embodiment of a mounting device for securing a display strip 100. The display strip 100 includes a plurality of screens 101. The mounting device includes a chassis 10, and a frame 20 located on the chassis 10. In this embodiment, the display strip 100 is substantially rectangular.

The chassis 10 includes a bottom plate 11, a front plate 12, and two side plates 13 (only one of the two side plates 13 is shown). The two side plates 13 are opposite to each other. In this embodiment, the bottom plate 11 is substantially perpendicular to the front plate 12 and the side plates 13, and the front plate 12 is substantially perpendicular to the side plates 13. A plurality of dividing plates 15 extends from each side plate 13. Each dividing plate 15 is substantially parallel to the front plate 12. A channel is defined between each two adjacent dividing plates 15 for receiving products (not shown).

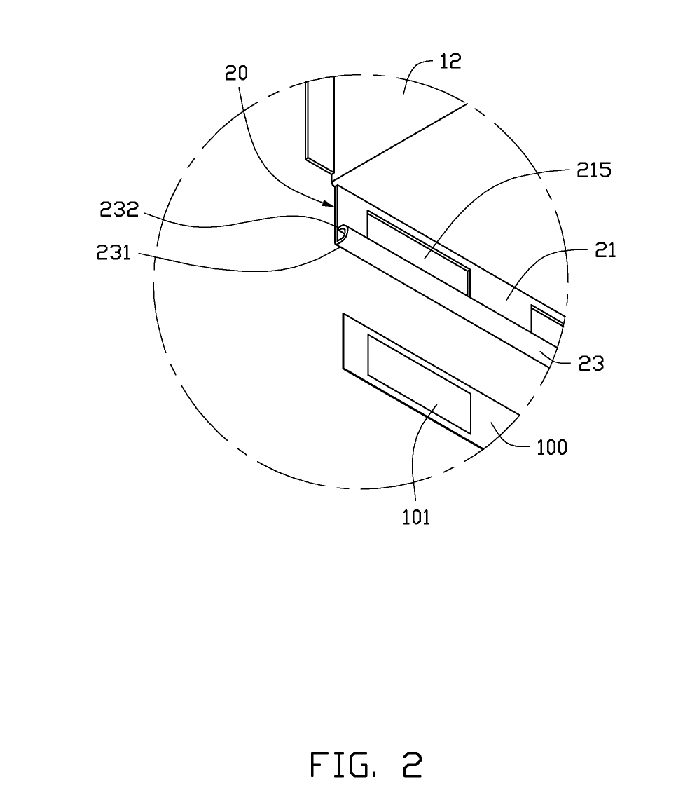

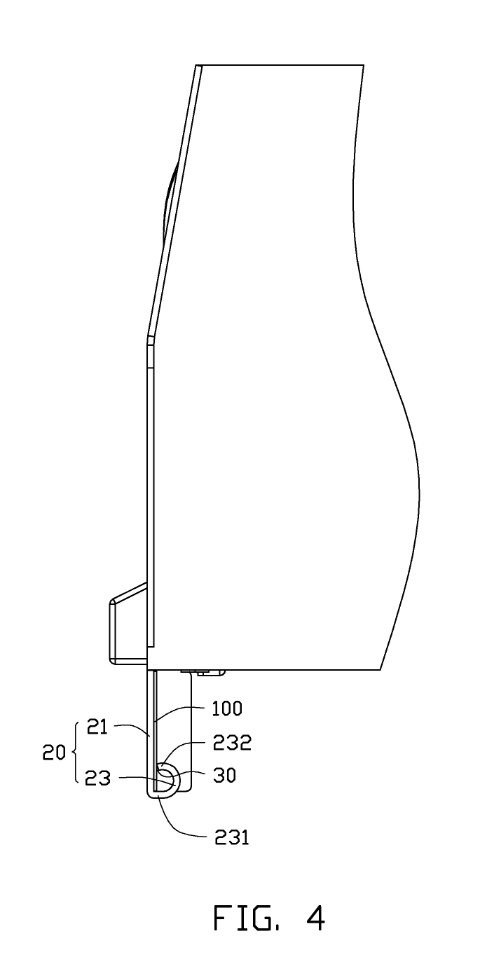

Referring to FIG. 2, the frame 20 includes a holding plate 21 and a limiting portion 23 extending from a bottom edge of the holding plate 21. The holding plate 21 extends downward from an edge of the bottom plate 11. In this embodiment, the holding plate 21 is substantially perpendicular to the bottom plate 11, and the holding plate 21 is integrally formed with the bottom plate 11. The bottom plate 11 defines a plurality of openings 215. In this embodiment, the limiting portion 23 is a curved piece that curves from the bottom edge of the holding plate 21 towards the bottom plate 11. The bottom edge of the holding plate 21 is substantially parallel to the bottom plate 11. The limiting portion 23 includes a first edge 231 and a second edge 232. The first edge 231 is connected to the bottom edge of the holding plate 21. A gap 30 (shown in FIG. 4) is defined between the second edge 232 and the holding plate 21, for securing the display strip 100. A width of the gap 30 is substantially equal to a thickness of the display strip 100.

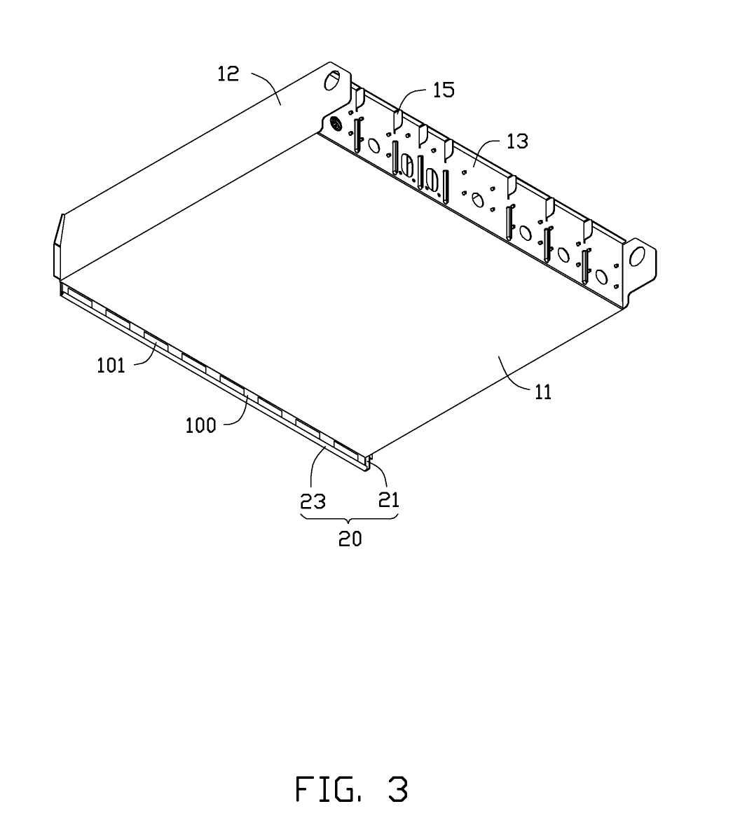

Referring to FIGS. 3 and 4, in assembly, the display strip 100 is inserted into the gap 30, and is positioned between the second edge 232 and the holding plate 21, such that each screen 101 is aligned with one of the plurality of openings 215.

The display strip 100 is slidable between the second edge 232 and the holding plate 21 to disengage from the gap 30.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and the arrangement of parts within the principles of the disclosure, to the full extent indicated by the broad general meaning of the terms in which the appended claims are expressed.

What is claimed is:

1. A mounting device, comprising:
a bottom plate of a chassis; and
a frame comprising a holding plate located on the bottom plate and a limiting portion extending from the holding plate;
wherein the limiting portion comprises a first edge and a second edge opposite to the first edge; the first edge extends from an edge of the holding plate; a gap is defined between the second edge and the holding plate, and the gap is configured for receiving a display strip; and the holding plate and the bottom plate are integral.

2. The mounting device of claim 1, wherein a distance between the second edge and the holding plate is substantially equal to a width of the display strip.

3. The mounting device of claim 1, wherein the holding plate is substantially perpendicular to the bottom plate.

4. The mounting device of claim 1, wherein the first edge is connected to a bottom edge of the holding plate, which is substantially parallel to the bottom plate; and the second edge extends towards the bottom plate.

5. The mounting device of claim 1, wherein the limiting portion is a curved piece.

6. The mounting device of claim 1, wherein the holding plate defines a plurality of openings, and each opening is configured for aligning with a screen in the display strip.

7. The mounting device of claim 1, further comprising a side plate and a plurality of dividing plates, wherein the side plate is secured to the bottom plate, and the plurality of dividing plates are secured to the side plate; and each adjacent two dividing plates defines a goods channel.

8. A mounting device, comprising:
a bottom plate of a chassis; and
a frame comprising a holding plate located on the holding plate and a limiting portion extending from the holding plate;
wherein the limiting portion comprises a first edge and a second edge opposite to the first edge; the first edge extends from an edge of the holding plate, and the second edge extend curled from the first edge towards the holding plate; a gap is defined between the second edge and the holding plate, and the gap is configured for receiving a display strip.

9. The mounting device of claim 8, wherein a distance between the second edge and the holding plate is substantially equal to a width of the display strip.

10. The mounting device of claim 8, wherein the holding plate is substantially perpendicular to the bottom plate.

11. The mounting device of claim 8, wherein the first edge is connected to a bottom edge of the holding plate, which is substantially parallel to the bottom plate.

12. The mounting device of claim 8, wherein the limiting portion is a curved piece.

13. The mounting device of claim 8, wherein the holding plate defines a plurality of openings, and each opening is configured for aligning with a screen in the display strip.

14. The mounting device of claim 8, further comprising a side plate and a plurality of dividing plates, wherein the side plate is secured to the bottom plate, and the plurality of dividing plates are secured to the side plate; and each adjacent two dividing plates defines a goods channel.

15. The mounting device of claim 8, wherein the holding plate and the bottom plate are integral.
